(19) United States
(12) Patent Application Publication
(10) Pub. No.: US 2015/0081788 A1
(43) Pub. Date: Mar. 19, 2015

(54) SERVER APPARATUS, NON-TRANSITORY COMPUTER-READABLE STORAGE MEDIUM HAVING INFORMATION PROCESSING PROGRAM STORED THEREIN, INFORMATION PROCESSING SYSTEM, AND INFORMATION PROCESSING METHOD

(71) Applicant: NINTENDO CO., LTD., Kyoto-shi (JP)

(72) Inventor: Hiroki TAKUMA, Kyoto (JP)

(21) Appl. No.: 14/479,681

(22) Filed: Sep. 8, 2014

(30) Foreign Application Priority Data
Sep. 13, 2013 (JP) 2013-190592

(51) Int. Cl. H04L 29/06

(52) U.S. Cl. CPC H04L 65/403
USPC 709/204

(57) ABSTRACT

In an example system, information about a browse action which is a predetermined operation performed, for a content posted by a user, by another user browsing the content, is stored. Next, the display manner for the content is determined based on the browse action information about the content. At this time, the display manner is determined so that the display manner becomes different from a display manner for a content in a normal state. Then, browse source data for displaying the content in the determined display manner is generated.

### CROSS REFERENCE TO RELATED APPLICATION

The disclosure of Japanese Patent Application No. 2013-190592, filed on Sep. 13, 2013, is incorporated herein by reference.

### FIELD

The exemplary embodiments relate to an information processing system that allows posting and sharing of contents by users, and a server apparatus used therein.

### BACKGROUND AND SUMMARY

In recent years, hand-held information terminals such as a smartphone are widely used. Users have increased opportunities of utilizing various network services with use of such hand-held information terminals. Besides, a so-called social networking service (SNS) is also widely used. The SNS can be utilized with not only a personal computer but also a hand-held information terminal as described above. Some of such SNSs provide the one that can be utilized by only hand-held information terminals. Actually, there are an increased number of users enjoying SNS by hand-held information terminals. In such SNS, users can browse each other's posts. On a screen for browsing such posts, the posts are arranged in chronological order, and all displayed in the same display manner.

As various kinds of entertainments come out recently, it is assumed that a time that a user can use for SNS decreases. Therefore, regarding the utilization of SNS by hand-held information terminals, it is assumed that users browse SNS in a so-called “free time” or “spare time”. Considering such browsing utilization circumstances, a mechanism for efficiently enjoying SNS with decreased time may be desirable.

In addition, users of SNS are remarkably increasing. Therefore, the number of information pieces such as the posts to be browsed in SNS is likely to increase. Such increase in the information number is also considered to be, as it were, flood of information, and this hampers efficient browsing. Particularly, in light of broad use of hand-held information terminals as described above, there are many opportunities of utilizing SNS by such hand-held information terminals. However, generally, hand-held information terminals have a small screen size (display area) (as compared to personal computers and the like). Considering the information flooding situation as described above, it may be desirable to efficiently display information that a user wants to view within such a small display area.

Therefore, the exemplary embodiments will be given to describe a server, a non-transitory computer-readable storage medium having information processing program stored therein, an information processing system, and an information processing method, that can provide a mechanism that allows a user to further efficiently browse information that the user wants to view within a short time and a small display area. It is noted that computer-readable storage media as used herein include a magnetic medium such as a flash memory, a ROM, or a RAM, and an optical medium such as a CD-ROM, a DVD-ROM, or a DVD-RAM.

Configuration examples to achieve the above are as follows.

One configuration example is a server used in an information processing system that allows posting and sharing of contents by users. The server includes a processor configured to: store information related to a browse action which is a predetermined operation performed, for a content posted by a user, by another user who browses the content; determine, based on the information, a display manner for the content posted by the user or for another content posted by the user, so that the display manner becomes different from a display manner for a content in a normal state; and generate browse source data for displaying the content in the determined display manner.

The above configuration example makes it possible to further efficiently browse information that a user wants to view, within a small display area such as a screen of a smartphone, for example.

In another configuration example, the processor may be further configured to transmit the browse source data. In addition, the processor may determine the display manner, based on the information related to a browse action performed by a first user, the processor may generate the browse source data for displaying a content to be browsed by a second user different from the first user, in the display manner determined based on the information related to the browse action performed by the first user, and the processor may transmit the browse source data to the second user.

The above configuration example makes it possible to present a post content in a display manner in which mainly browse actions by other users are reflected, thereby allowing a user to easily know a content or the like that is much talked about at a given point of time, for example.

In another configuration example, the processor may store the information related to a browse action in a cumulative manner, and may determine the display manner, based on a cumulative result of the browse actions.

The above configuration example makes it possible to change the display manner of a predetermined post content, based on various viewpoints such as a content that has been much talked about in the last several months, the number of times of browse actions for each content, etc., for example.

In another configuration example, the processor may be further configured to transmit the browse source data. In addition, the processor may store the information related to a browse action performed, by a first user, for a content of another user, the processor may determine a display manner for a content that has been posted by the other user and that is to be browsed by the first user, based on the information related to the browse action performed by the first user, the processor may generate the browse source data for displaying the content in the display manner determined based on the browse action performed by the first user, and the processor may transmit the browse source data to the first user.

The above configuration example makes it possible to reflect mainly browse actions by a browsing person in the display manner so that post contents of a user whom the browsing person is highly interested in or concerned with, a user with whom the browsing person has a familiar relationship, etc., can be presented in a conspicuous manner, thus allowing the browsing person to efficiently browse information that the browsing person wants to view.

In another configuration example, the processor may repeatedly determine the display manner.

In the above configuration example, while a user repeatedly utilizes the system, the display manner of contents can be changed without the user being aware thereof.

In another configuration example, the processor may generate browse source data so that a plurality of the contents are displayed, and may determine the display manner for each of the plurality of contents.

The above configuration example allows a user to easily grasp which content is much talked about, on a screen displaying a list of a plurality of contents, for example.

In another configuration example, the processor may generate browse source data so that, on a browse screen which displays a content based on the browse source data, at least a part of each content contained in the browse source data is displayed, and the browse action may be an operation for requesting display of an entirety or a detail of the content that is displayed only partially. The processor may generate browse source data so that a feedback button that allows feedback for each content displayed based on the browse source data is also displayed, and the browse action may be an operation that a browsing user pushes the feedback button.

The above configuration example makes it possible to change the display manner based on an operation to a content that a browsing person is, at least, interested in or concerned with.

In another configuration example, the processor may determine a display manner for a content for which the browse action has been performed, so that a display area thereof becomes larger than that of a content in the normal state.

The above configuration example allows a user to intuitively grasp a content that the user wants to view.

In another configuration example, the processor may generate the browse source data so that contents displayed based on the browse source data are arranged in chronological order.

The above configuration example makes it easy to grasp a content that has been posted recently or a content that is much talked about now, for example, thereby enhancing convenience for a user.

In another configuration example, the processor may be further configured to store profile information related to each user, and the processor may determine the display manner, based on a result of comparison of the profile information among the users, and based on the information related to the browse action.

The above configuration example makes it possible to further conspicuously display a content of a user having the same hobby as a browsing person, for example.

In another configuration example, the processor may generate the browse source data so that, when a content for which the display manner is changed is displayed within a screen of a predetermined terminal that has received the browse source data, predetermined control other than change of the display manner, for attracting user's attention, is further performed on the predetermined terminal.

The above configuration example allows a user browsing contents to easily notice that a content whose display manner is changed exists (for example, when the content comes into a screen by scroll operation).

Another configuration example is an information processing system that includes at least one server and a plurality of terminals and allows posting and sharing of a content by users with use of the terminals. Each terminal includes a processor configured to: transmit a content to the server; transmit, to the server, a browse request indicating a request for displaying a browse screen for displaying the content; transmit, to the server, information related to a browse action which is a predetermined operation performed for the content by a user who browses the content; and receive browse source data as a base of the browse screen from the server, and generate and display the browse screen based on the received browse source data. The server includes a processor configured to: receive the content transmitted from a user; store information related to the browse action transmitted by the browse action transmission; determine, based on the information, a display manner for the content posted by the user or for another content posted by the user, so that the display manner becomes different from a display manner for a content in a normal state; generate, in accordance with reception of the browse request, the browse source data for displaying the content in the determined display manner; and transmit the generated browse source data to the terminal that has performed the request. Further, the processor may generate the browse source data so that a plurality of the contents are contained in the browse screen, the processor may generate and display the browse screen containing the plurality of contents, the processor may transmit the information related to a browse action performed for one of the contents contained in the browse screen, the processor may determine, in accordance with a browse request performed after the transmitted information related to the browse action has been stored, a display manner for the content for which the browse action has been performed, based on the transmitted information, the processor may generate the browse source data so that the display manner for the content for which the browse action has been performed is changed to the determined display manner, and the processor may transmit the browse source data containing the content for which the display manner is changed, to the terminal that has performed the browse request.

The above configuration example makes it possible to further efficiently browse information that a user wants to view, within a small display area such as a screen of a smartphone, for example. In addition, the above configuration example makes it possible to present a post content in a display manner in which mainly browse actions by other users are reflected, thereby allowing a user to easily know a content or the like that is much talked about at a given point of time, for example.

Another configuration example is a server used in an information processing system that allows posting and sharing of a content by a user. The server includes a processor configured to: store information related to a browse action which is a predetermined operation performed, for a user who has posted a content, by another user; determine, based on the information related to the user who has posted the content, a display manner for contents of the user who has posted the content, so that the display manner becomes different from a display manner for a content in a normal state; and generate browse source data for displaying the content in the determined display manner.

The above configuration example makes it possible to further efficiently browse information that a user wants to view, within a small display area such as a screen of a smartphone, for example. In addition, the above configuration example makes it possible to present a post content in a display manner in which mainly browse actions by other users are reflected, thereby allowing a user to easily know a content or the like that is much talked about at a given point of time, for example.

According to the exemplary embodiments, it becomes possible to further efficiently browse information that a user wants to view.

### BRIEF DESCRIPTION OF THE DRAWINGS

FIG. 1 is a schematic diagram showing a non-limiting example of the entirety of an information processing system according to an exemplary embodiment;

FIG. 2 is a functional block diagram showing a non-limiting example of the configuration of a terminal apparatus 10;

FIG. 3 is a functional block diagram showing a non-limiting example of the configuration of the server apparatus 20;

FIG. 4 is a non-limiting example of a browse screen of the exemplary embodiment;

FIG. 5 is a non-limiting example of a browse screen of the exemplary embodiment;

FIG. 6 is a diagram for explaining a non-limiting example of the summary of processing operation according to the exemplary embodiment;

FIG. 7 is a diagram for explaining a first display mode of the exemplary embodiment;

FIG. 8 is a diagram for explaining a second display mode of the exemplary embodiment;

FIG. 9 is a diagram showing a non-limiting example of a program and information stored in a main memory 25 of the server 20;

FIG. 10 is a non-limiting example of the data structure of user data 62;

FIG. 11 is a non-limiting example of the data structure of favorite user data 69;

FIG. 12 is a non-limiting example of the data structure of post content data 63;

FIG. 13 is a non-limiting example of the data structure of browse action data 85;

FIG. 14 is a diagram showing a non-limiting example of a program and information stored in a main memory 15 of the terminal apparatus 10;

FIG. 15 is a flowchart showing a non-limiting example of the detailed processing by the terminal apparatus 10; and

FIG. 16 is a flowchart showing a non-limiting example of the detailed processing by the server 20.

### DETAILED DESCRIPTION OF NON-LIMITING EXAMPLE EMBODIMENTS

Hereinafter, the exemplary embodiments will be described. It is to be understood that as used herein, elements and the like written in a singular form with a word “a” or “an” attached before them do not exclude those in a plural form.

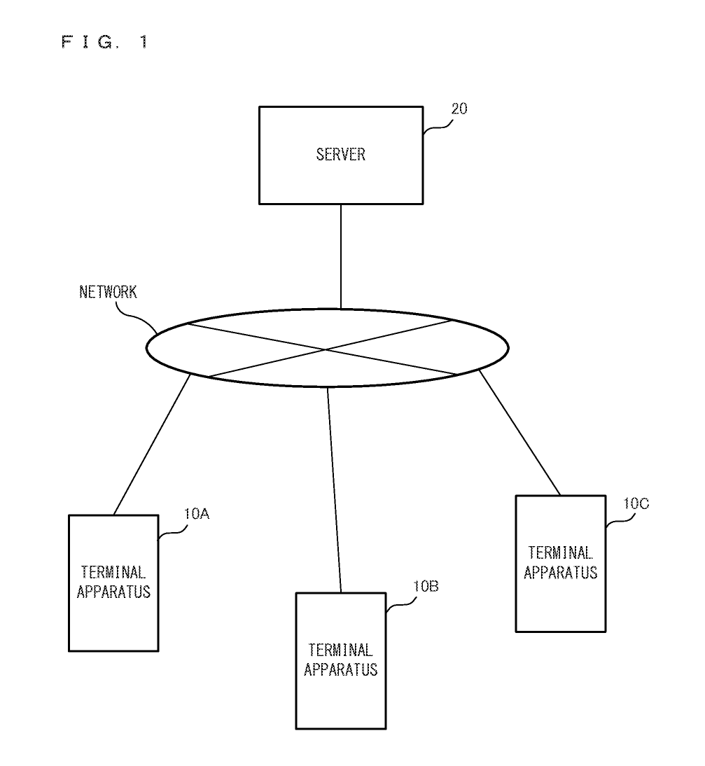

FIG. 1 is a schematic diagram showing a non-limiting example of the entirety of an information processing system according to an exemplary embodiment. In the information processing system of the exemplary embodiment, a server 20 and a plurality of terminal apparatuses 10A to 10C (hereinafter, may be collectively referred to as terminal apparatuses 10) are configured to be connectable and communicable with each other via a network (for example, the Internet). The terminal apparatuses are, for example, hand-held terminal apparatuses such as a smartphone, a mobile phone, or a PDA, or so-called tablet-type information processing apparatuses (in another exemplary embodiment, they may be terminal apparatuses such as a personal computer). The exemplary embodiment assumes that in such a system, a so-called social networking service (hereinafter, SNS) is executed. In addition, the exemplary embodiment assumes, particularly, a membership service of community type, among such services. For example, a service in which users are to be registered for utilization (a service in which user account information or the like is stored in the server 20) is assumed. Each user can “post” a predetermined content (for example, a predetermined text) (to the server 20). Hereinafter, this content is referred to as a “post content”. In addition, each user can “browse” a post content of another user (or the user's own post content). Further, each user can make a predetermined action to each post content. For example, for a certain post content, each user can perform “feedback” such as giving a “comment” or pushing a button indicating a positive evaluation or a negative evaluation (e.g., so-called “good!” button or “bad” button). Hereinafter, such actions are referred to as “browse action”.

In the exemplary embodiment, the following actions are also regarded as a browse action. For example, an operation of requesting detailed display of a post content is also regarded as a browse action. This is an operation of pressing a “display whole text” button in the case where not the whole text of a post content is displayed at the initial display but about the first one or two lines are only displayed, for example. That is, a predetermined operation performed by a user with respect to a certain post content is regarded as a browse action. In addition, for example, on a screen displaying a list of post contents in the longitudinal direction, a scroll speed when a screen scroll operation in the longitudinal direction is performed, and a time during which each post content is browsed, are also included in browse actions here. For example, in the case where the scroll speed is fast, it is considered that post contents are being skipped, and in such a state, if the scroll speed is suddenly slowed down or the scroll is stopped, it is considered that the post content displayed on the screen at this time is being carefully read (focused on). Therefore, such a screen transition condition or a screen scroll operation is detected, and whether or not a user is focusing on each post content is determined based on the detection. Then, if it is determined that the post content is focused on, it is determined that a browse action as described above is performed for the post content. In addition, for example, an operation of enlarging an image contained in a post content and an operation of clicking a hyperlink contained in a post content are also regarded as browse actions described above.

Besides, in the case where a post content itself is an image such as a picture or an illustration, an operation of displaying the image in an enlarged manner (for example, when the image is clicked or touched, the image is displayed on another screen or another window in a larger size than that displayed within the post content) is also regarded as the above browse action. In addition, when a feedback such as the above positive evaluation or negative evaluation is performed for the image, it is also determined that the above browse action is performed. In addition, for example, in the case where a post content is sound data or moving image data, for example, when an operation of reproducing moving image data displayed as a still image in the post content is performed, it is also determined that the above browse action is performed. Besides, in the case where a post content can be downloaded, when an operation of downloading the post content is performed, it is also determined that the above browse action is performed.

In addition, regarding the relationship among users, for example, only users for which the relationship “friend” is set may be allowed to browse each other's content. That is, in browsing by each terminal apparatus, a post content posted by a user who is not a “friend” may not be able to be browsed, and only a post content posted by a user in a “friend” relationship may be displayed. Here, “friend” in the exemplary embodiment refers to a relationship in which users are authenticated by each other. For example, a user A transmits a “friend request” to a user B (for which a friend relationship with the user A has not been set yet). In response, the user B approves the request, whereby both users are set as “friends” for the first time.

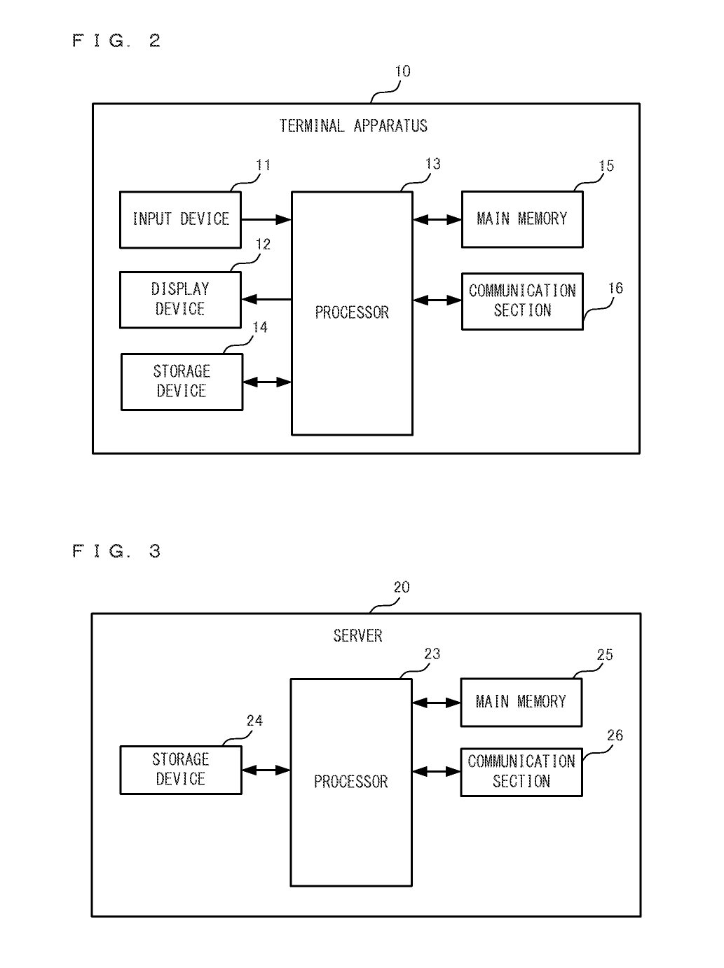

FIG. 2 shows a non-limiting example of the functional block configuration of the terminal apparatus 10. In FIG. 2, the terminal apparatus 10 has an input device 11, a display device 12, a processor 13, a storage device 14, a main memory 15, and a communication section 16. The input device 11 is operated by a user of the terminal apparatus 10 and outputs a signal corresponding to the user's operation. The input device 11 is, for example, a cross switch, a push button, or a touch panel. The display device 12 displays an image generated in the terminal apparatus 10, on a screen thereof. The display device 12 is, typically, a liquid crystal display device. The storage device 14 stores a computer program to be executed by the processor 13 and various kinds of data to be used in the program. The storage device 14 is, for example, a flash EEPROM or a hard disk device. The main memory 15 temporarily stores a computer program and information. The communication section 16 establishes connection to a network by wired or wireless communication, and transmits predetermined data to the server 20 or another terminal apparatus or receives predetermined data from the server 20 or another terminal apparatus.

FIG. 3 shows a non-limiting example of the functional block configuration of the server 20. In FIG. 3, the server 20 has a processor 23, a storage device 24, a main memory 25, and a communication section 26. The storage device 24 stores a computer program to be executed by the processor 23 and various kinds of data to be used in the program. The storage device 24 is, for example, a hard disk device. The main memory 25 temporarily stores a computer program and information. The communication section 26 establishes connection to a network by wired or wireless communication, and performs transmission and reception of predetermined data with another terminal apparatus.

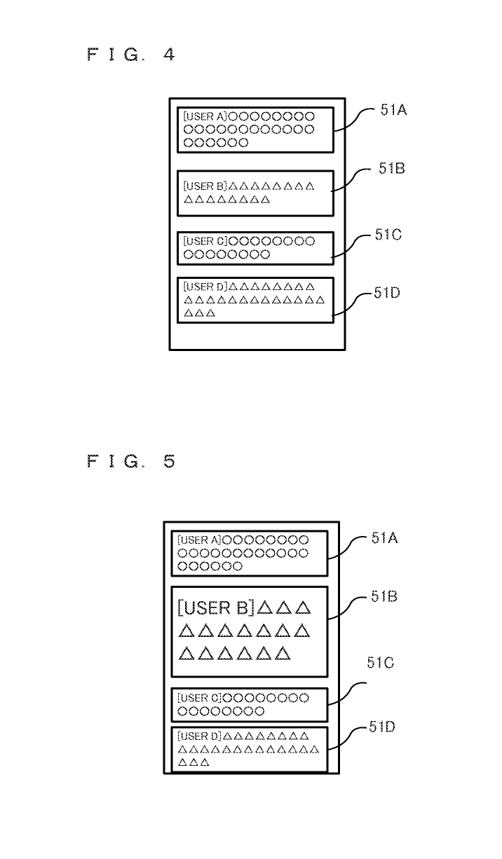

Next, the summary of operation of information processing (information processing executed by each terminal apparatus 10) executed in the information processing system of the exemplary embodiment will be described. The processing of the exemplary embodiment roughly performs the following operation. That is, processing is performed such that, when a user browsing a certain post content performs a browse action for the certain post content, a display manner for the post content is changed in accordance with the type of the browse action. Here, change of the display manner in the exemplary embodiment is performed for the purpose of increasing or emphasizing information to be displayed. For example, the font size of the post content is enlarged, the color of characters is changed, or the size of a display area in which the post content is displayed is increased (as a result of the area increase, the number of characters that can be displayed also increases), whereby the display manner is changed. Therefore, processing in which display (the display area or the font size) of the post content itself is not particularly changed, e.g., processing of merely adding small indication of the number of comments at a corner of the display area of the post content, is not included in the change of display manner as used herein. Hereinafter, processing of enlarging the font size and enlarging the display area is referred to as the “change of display manner”, as an example. For example, when a predetermined number or more of positive evaluations have been made for a certain post content, on a browse screen containing the certain post content, display is performed such that the font size and the display area of the certain post content are larger than those of other post contents, whereby a post content with high evaluation can be made conspicuous. FIG. 4 is a non-limiting example of a browse screen before the above browse action is performed. In FIG. 4, four post contents 51A to 51D by users A to D are displayed (it is noted that although not shown, it is assumed that a button for the aforementioned feedback and a button for detailed display are also displayed as appropriate). FIG. 5 is a non-limiting example of a browse screen containing a post content for which the display manner has been changed in response to a browse action. FIG. 5 shows a screen example in which a predetermined number or more of operations indicating positive evaluation have been performed for the post content 51B of the user B in FIG. 4. In FIG. 5, display is performed such that the font size and the display area of the post content 51B are larger than those of the other post contents 51A, 51C, and 51D.

Besides, in the case where a post content is an image such as a picture or an illustration, the image may be displayed in a larger size than the other images or may be displayed in an emphasized manner by surrounding the image with a color frame, whereby the display manner may be changed.

Hereinafter, a state in which a display manner is not changed, as shown by the post contents 51A to 51D in FIG. 4 or the post contents 51A, 51C, and 51D in FIG. 5, is referred to as a “normal state”, and display without change of display manner is referred to as “display in normal state”. In other words, a display manner set as a default in a system is referred to as a “normal state”, here. For example, regarding font color, color in a normal state (default color) is black, and a color when the display manner has been changed in response to a browse action is blue, as an example.

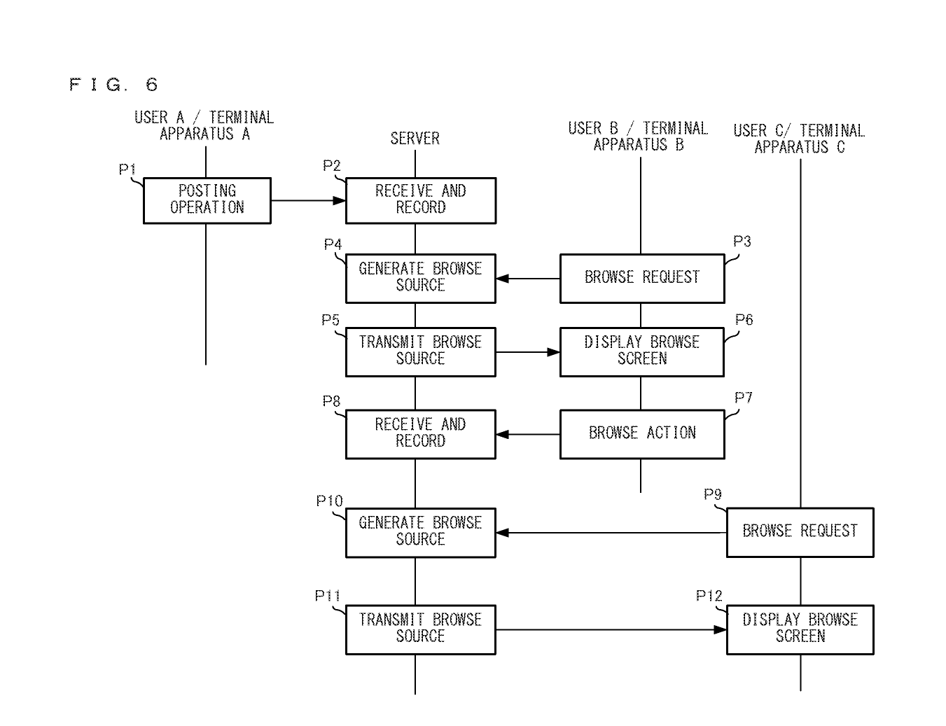

Next, with reference to FIG. 6, the above operation summary will be described more specifically. FIG. 6 is a diagram for explaining a non-limiting example of the operation summary of the processing in the exemplary embodiment. In FIG. 6, operations and processes to be performed by the terminal apparatus A operated by the user A, the terminal apparatus B operated by the user B, the terminal apparatus C operated by the user C, and the server, are shown being arranged in the vertical axis direction in chronological order. It is noted that the user A, the user B, and the user C are assumed to be set as “friends” of each other.

In FIG. 6, first, the user A operates the terminal apparatus A to input a predetermined text, and transmits (posts) the text as a post content to the server (P1). Here, in the exemplary embodiment, for convenience in the description, the post content is assumed to be a text. In another exemplary embodiment, the post content may be a picture, a sound, or a moving image, for example, or may be a combination of them (for example, a combination of a text and a picture).

The server receives the above post content, and stores the post into a predetermined storage medium such that the post is associated with the user A (P2). It is noted that although not shown, it is assumed that post contents are transmitted also from users other than the user A as necessary, and are stored in the server.

In another exemplary embodiment, in the server, only the received post content may be stored without being associated with the user of the post content.

Thereafter, based on an operation by the user B, the terminal apparatus 10B transmits, to the server, a browse request for requesting display of a list of a plurality of post contents (P3). For example, when an SNS application is started in the terminal apparatus B, processing of requesting the server for the “recent” posts (posts within a past predetermined period from the point when the browse request has been performed), or the like is executed, whereby the browse request is transmitted. It is noted that for convenience in the description, here, the “recent” posts include the above post content of the user A.

The server receives the browse request from the terminal apparatus B, and in accordance with this, generates data as a base of a browse screen to be displayed on the terminal apparatus B, that is, generates a browse source (P4). That is, the server reads data of a predetermined post content (typically, a plurality of post contents) recorded in the server, with reference to a friend relationship of the user who has transmitted the browse request. In other words, the server extracts post contents of users for which a friend relationship with the user who has transmitted the browse request is set. Then, the server generates data as a source for a browse screen on which, for example, these post contents are to be displayed as a list so as to be sorted in chronological order in terms of post date or the like, the data being written in a markup language such as HTML, for example. In addition, at this time, processing of generating the browse source such that a display manner of a predetermined post content is different from that in the normal state is also performed as necessary, and this will be described later. It is noted that for convenience in the description, it is assumed that, at this time, the display manner of any post contents has not been changed yet (they are displayed in the normal state).

Next, the server transmits the browse source to the terminal apparatus B (P5). In response, the terminal apparatus B receives the browse source, and based on the browse source, generates and displays a browse screen (for example, see FIG. 4) on a screen (P6). For example, the terminal apparatus B renders the browse source (for example, data written in a markup language such as HTML), thereby generating and displaying a browse screen.

Next, it is assumed that the user B performs a browse action on the browse screen (P7). For example, it is assumed that the user B performs an operation (for example, pushes a “good!” button) to indicate a positive evaluation for the post content of the user A. In this case, this operation content is transmitted to the server. The server receives this operation content, and records data relevant to the operation content such that the data is associated with the targeted post content (in this case, the post content of the user A) (P8). It is noted that in the exemplary embodiment, such data indicating browse actions are cumulatively stored.

Thereafter, it is assumed that another terminal apparatus C transmits a browse request to the server (P9). It is noted that this browse request also includes the post content of the user A. The server generates a browse source in accordance with the browse request (P10). At this time, the above browse action is reflected so that a display manner of a post content is made different (changed) from that in the normal state. For example, the display manner is changed so that the font size and the display area become larger than those in the normal state. Whether or not to change the display manner or how to change the display manner may be determined based on the cumulative value of the browse actions. For example, if the above-described operation indicating a positive evaluation has been performed a predetermined number of times or more, the display manner may be determined to be changed. In addition, in accordance with the number of times, for example, the font size may be changed in a step-by-step manner.

Then, after the browse source set so as to change the display manner is generated as described above, the browse source is transmitted to the terminal apparatus C that has transmitted the browse request (P11). The terminal apparatus C that has received the browse source generates a browse screen based on the browse source, and displays the browse screen on a screen thereof (P12). As a result, for example, as shown in FIG. 5, a browse screen in which the font size and the display area of the post content (for which the browse action for positive evaluation has been performed) are enlarged is displayed.

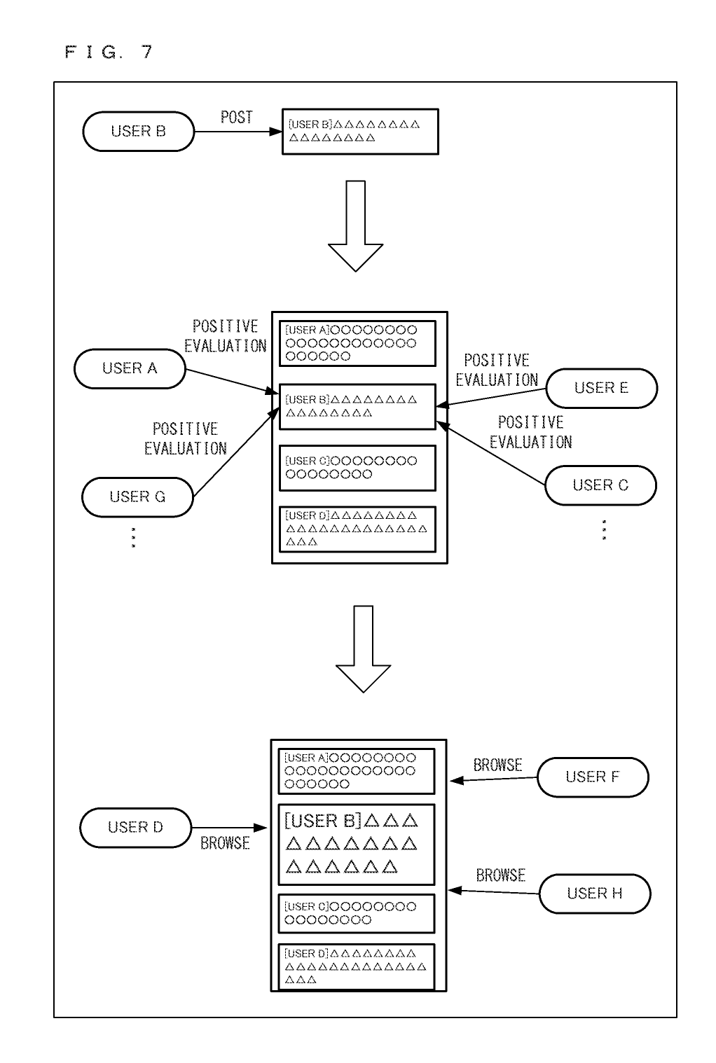

Thus, in the case where a browse action has been performed for a post content of a user, thereafter, when a browse screen is displayed on a predetermined terminal, the display manner of the post content is changed (in accordance with the type of the browse action). That is, browse actions by (mainly) other users are reflected in change of the display manner. For example, it is assumed that the display manner is changed when a browse action indicating a positive evaluation has been performed a predetermined number of times or more. FIG. 7 is a schematic diagram showing a non-limiting example of such a flow. In FIG. 7, the case where a positive evaluation has been performed a predetermined number of times or more for the post content of the user B, is shown. In this case, when a browse screen is displayed, for example, a popular post content or a post content for which many favorable/positive browse actions are performed is displayed so as to be more conspicuous than other post contents. Therefore, browsing users can easily and visually grasp which post content is popular or the like (that is, popularity, topicality, or trend). As a result, it becomes easy to collect information (posts) necessary for a user or desired by a user, thus enhancing convenience and efficiency for a user to browse.

In the example of FIG. 7, the case where the display manner for each post content for which the user A or the like has directly performed browse actions is changed is shown as an example. That is, the case where a display manner is changed on a “post content” basis is shown as an example. In another exemplary embodiment, the display manner for all post contents of the user B, as well as the one shown in FIG. 7, may be changed. That is, a display manner may be changed on a “posting person” basis. For example, in the case where, among a plurality of post contents by the user B, there are a predetermined number or more of post contents each of which has received a predetermined number or more of positive evaluations, the display manner for all post contents posted by the user B may be changed. For example, it is assumed that the user B has posted ten post contents. Then, if there are six or more post contents for each of which a positive evaluation has been performed twenty times or more, the display manner for all post contents (including both of contents posted in the past and contents that will be posted in the future) by the user B may be changed. In another example, in the case where, for example, the total number of positive evaluations for all post contents of the user B is equal to or greater than a predetermined number, the display manner for all post contents posted by the user B may be changed. For example, in the case where the user B has posted ten post contents, if the total number of times of positive evaluations for them is sixty or more (that is, whichever post content has received a positive evaluation, if a positive evaluation has been performed sixty or more times), the display manner for all post contents posted by the user B may be changed. Further, such determination as described above may be performed for contents that have been posted in the past three months, for example, among all post contents of the user B. That is, the above determination may be performed using a specified period for assessing the number of times of positive evaluations or the like.

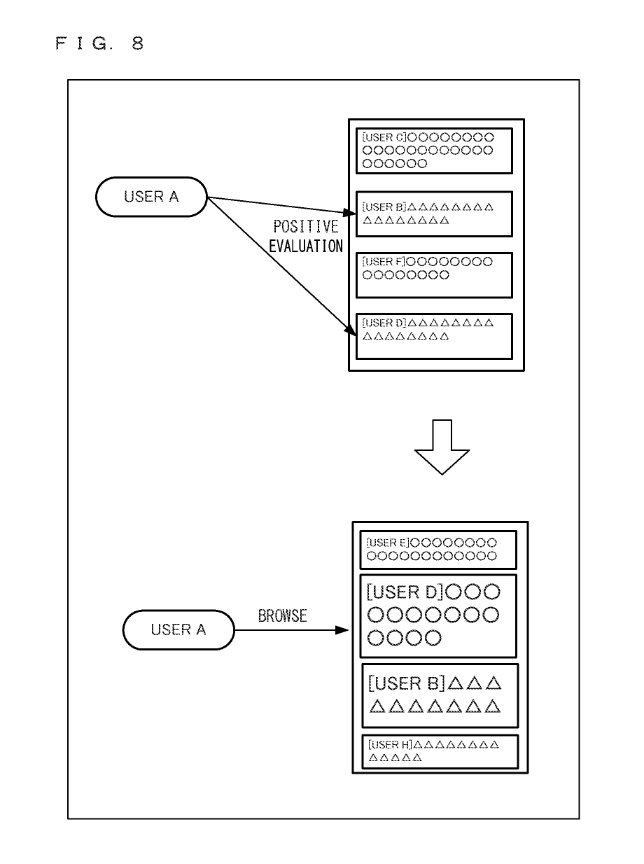

In the exemplary embodiment, as processing performed by focusing on a user who has performed a browse action, the following processing is also executed. For example, processing is also performed in which, in accordance with a browse action that a certain user has performed for a post content of “another user”, display is performed for the certain user such that the display manner of all other posts of the other user is changed. So to speak, processing is performed in which such “another user” is recorded as a user whom the certain user is interested in or focuses on (hereinafter, for convenience sake, referred to as a “favorite” user), and display is performed for the certain user such that the display manner for all posts of the other user is changed. That is, browse actions that a user has performed in the past are reflected in change of a display manner. FIG. 8 is a schematic diagram showing a non-limiting example of such processing. For example, it is assumed that the user A displays a browse screen on the user A's terminal apparatus A and post contents of the users C, B, F, and D are displayed on in chronological order (starting from the latest post date) on the screen. Then, it is assumed that the user A performs browse actions indicating a positive evaluation for the post contents of the users B and D. In this case, information indicating a user for whom the user A has performed the positive evaluation (in this case, information indicating the users B and D) is stored into the server 20 such that the information is associated with the user A. Thereafter, when the user A requests display of a browse screen, if a post content of the user D or the user B is contained in the screen, the server 20 generates a browse source for performing display with the display manner for the post content being changed, and performs transmission processing. As a result, processing is performed in which the display manner for all post contents of the user B and the user D is changed, including not only post contents for which the browse action has been directly performed but also post contents that will be posted later. Thus, it becomes possible to display, in a conspicuous manner, posts of familiar users (e.g., family or lover) for the user A or users (who are not familiar but) whom the user A is interested in or concerned with. Therefore, it is possible to provide a browse screen in accordance with each user's preference or the like, thereby enhancing browse performance and convenience.

In addition, if a display manner is changed in the case where a browse action has been performed a predetermined number of times or more, a user can recognize that another user for whom the user has performed a browse action many times is a user with high familiarity or a user with high interest or concern. For example, it is assumed that the user A has performed a browse action many times for a content of a user B (who is not familiar). In this case, even if the user A does not consciously have an interest in the user B at first and the user A has performed the browse action without much thought, as a result of several times of browse actions, the display manner for contents of the user B is changed, whereby the user A can recognize later that the user A is interested in the user B.

Hereinafter, in the terminal apparatus 10, a mode of displaying a browse screen with the display manner being changed mainly based on another user's browse action as shown in FIG. 7 is referred to as a “first display mode”. On the other hand, a mode of displaying a browse screen with the display manner being changed based on a browse action of a user of said terminal apparatus 10 as shown in FIG. 8 is referred to as a “second display mode”. In the exemplary embodiment, the first display mode and the second display mode can be switched therebetween by a predetermined operation by the user.

In another exemplary embodiment, the first display mode and the second display mode may be used simultaneously. In addition, at this time, the display manner in the first display mode and the display manner in the second display mode may be different from each other. For example, both the first display mode and the second display mode may be used simultaneously such that the font color in the normal state is black, the font color in the first display mode is red, and the font color in the second display mode is blue.

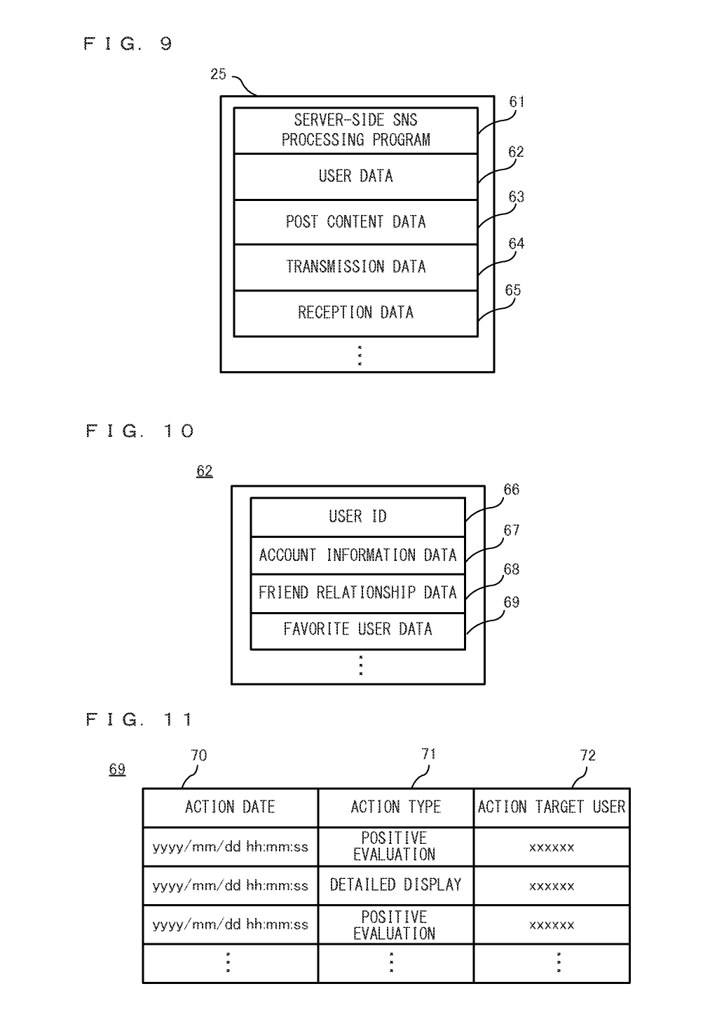

Next, with reference to FIGS. 9 to 16, the operation of information processing system in the exemplary embodiment will be described in more detail. First, data used in the present system will be described.

FIG. 9 is a diagram showing a non-limiting example of a program and information stored in the main memory 25 of the server 20. In the main memory 25, a server-side SNS processing program 61, user data 62, post content data 63, transmission data 64, reception data 65, and the like are stored.

The server-side SNS processing program 61 is a program for realizing a function (SNS server process) on the server side in the SNS in the exemplary embodiment. Specifically, the server-side SNS processing program 61 is a program for executing a flowchart process shown in FIG. 16 described later.

The user data 62 is data having recorded therein information relevant to users utilizing the SNS in the exemplary embodiment. FIG. 10 is a diagram showing a non-limiting example of the data structure of the user data 62. The user data 62 includes a user ID 66, account information data 67, friend relationship data 68, favorite user data 69, and the like. The user ID 66 is an ID for uniquely identifying each user. The account information data 67 is data indicating each user's account, profile, etc., such as login ID, password, name, age, hobby, hometown, old school, and the like of each user. The friend relationship data 68 is data indicating another user for whom a friend relationship with each user is set.

The favorite user data 69 is data indicating another user for whom the display manner is to be changed in the second display mode as described in FIG. 8. In the exemplary embodiment, the word “favorite” is used for convenience sake, and is merely intended to include another user whom each user is interested in or focuses on. FIG. 11 shows a non-limiting example of the data structure of the favorite user data 69. The favorite user data has a table structure composed of a collection of browse action records each having three items of an action date 70, an action type 71, and an action target user 72. The action date indicates a date when a user has performed a browse action. The action type 71 is data indicating the type of a browse action performed by a user. For example, this data indicates which the browse action is, among an operation indicating a positive evaluation, an operation indicating a negative evaluation, an operation requesting detailed display, and the like. The action target user 72 indicates a user ID 66 of a target user for whom each user has performed a browse action. It is possible to figure out to whom and in what degree (number of times, frequency, etc.) each user has performed a browse action, by referring to the action target user 72. Also, based on the number of browse action records of the favorite user data 69, the number of times of browse actions performed for each post content can be calculated. An action target user for whom this number of times is large can be determined to be a user with whom a user having performed such browse actions has a high “familiar” relationship or has high “interest/concern”, for example. In addition, whether or not a user is in favor of another user, or the like can be determined by referring to the action type 71. For example, this can be determined based on whether there are many positive evaluations or negative evaluations.

The above table structure is merely an example. Another table data structure may be used as long as the data structure can indicate an equivalent content as shown above.

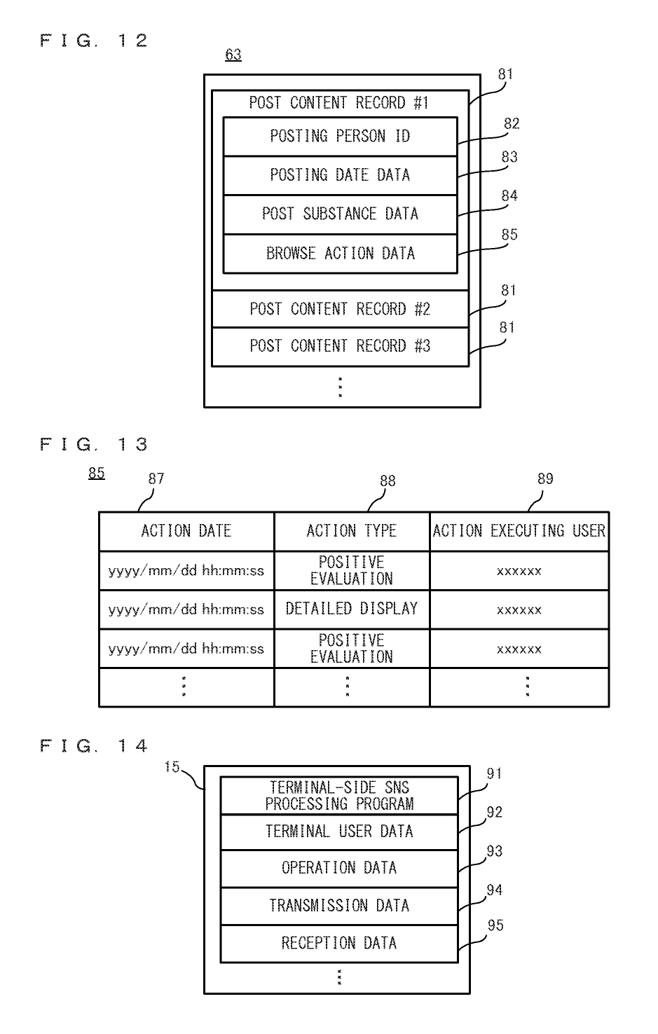

Returning to FIG. 9, the post content data 63 is data indicating a post content transmitted to the server 20 as described above. FIG. 12 is a diagram showing a non-limiting example of the data structure of the post content data 63. The post content data 63 contains a plurality of post content records 81, and is composed of each post content record 81, a posting person ID 82, posting date data 83, post substance data 84, and browse action data 85. Besides, although not shown, each post content record 81 also contains an ID that allows unique identification of itself. The posting person ID 82 indicates a user ID 66 of a user who has posted the post content. The posting date data 83 indicates a date when the post content has been posted. The post substance data 84 is data indicating the post content itself, and can also be considered to be a main body of the post content, such as text data or picture data.

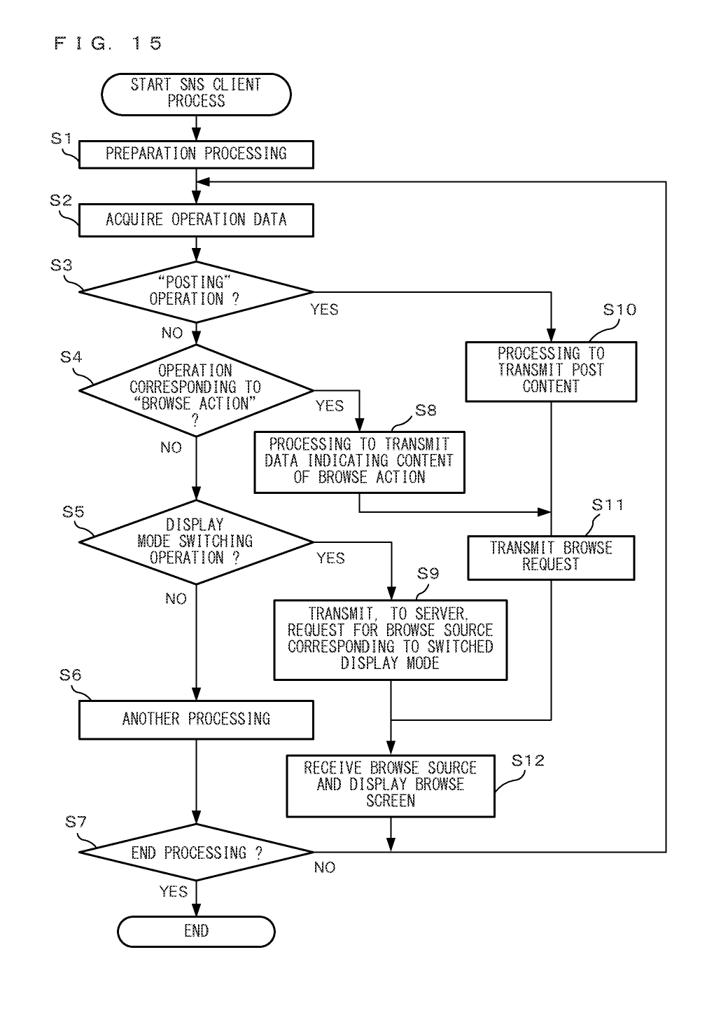

The browse action data 85 is data in which a browse action performed for the post content is recorded. In other words, this data can also be considered to be data in which information about browse actions performed for the post content is accumulated. FIG. 13 shows a non-limiting example of the data structure of the browse action data 85. This data has a table structure composed of a collection of browse action records each having three items of an action date 87, an action type 88, and an action executing user 89 (although not shown, each browse action record has an ID that allows unique identification). The action date 87 indicates a date when a browse action has been performed. The action type 88 is data indicating the type of a browse action. For example, this data indicates which the browse action is, among an operation indicating a positive evaluation, an operation indicating a negative evaluation, an operation requesting detailed display, and the like. The action executing user 89 indicates a user ID 66 of a user who has performed the browse action for the post content. Also, based on the number of the browse action records, the number of times of browse actions performed for the post content can be calculated. For example, if the number of records in which the action types 88 indicate “positive evaluation” is ten, it is determined that “positive evaluation” has been performed ten times for the post content. Besides, in the case of changing the display manner on a “posting person” basis as described above, for example, by calculating the number of positive evaluations contained in the browse action data 85 for each posting person ID 82, the number of positive evaluations for the posting person can be calculated.

Returning to FIG. 9, the transmission data 64 is data to be transmitted to the terminal apparatus 10, and contains a browse source and the like, for example. The reception data 65 is data received from the terminal apparatus 10, and contains data relevant to a post, a browse request, data indicating the content of an operation or a browse action performed on the terminal apparatus 10, and the like, for example.

Next, data used in the terminal apparatus 10 will be described. FIG. 14 is a diagram showing a non-limiting example of a program and information stored in the main memory 15 of the terminal apparatus 10. In the main memory 15, a terminal-side SNS processing program 91, terminal user data 92, operation data 93, transmission data 94, reception data 95, and the like are stored.

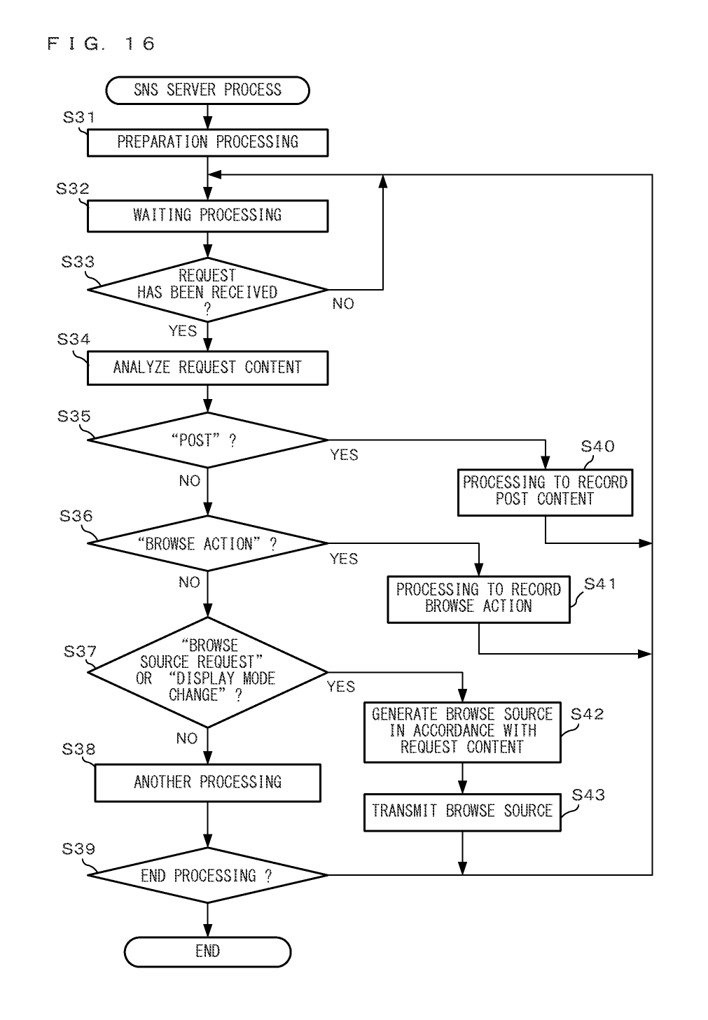

The terminal-side SNS processing program 91 is a program for realizing a function (SNS client process) on the terminal apparatus 10 side in the SNS in the exemplary embodiment. Specifically, this is a program for realizing a flowchart process shown in FIG. 15 described later.

The terminal user data 92 is data relevant to a user utilizing the SNS process on the terminal apparatus. In the terminal user data 92, mainly, data or the like for identifying a posting person and the like on the server side, for example, the same data as in the case of the user ID 66, is stored. The operation data 93 is data indicating the contents of various operations performed on the terminal apparatus 10.

The transmission data 94 is data to be transmitted to the server 20. The transmission data 94 is generated based on the terminal user data 92, the operation data 93, and the like, and contains, for example, data indicating a user ID and a post content of the user, a browse request, and a browse action, data for requesting switch of the display mode, and the like. For example, the transmission data 94 is formed by a header section and a body section. The header section indicates a user ID and the kind of the transmission data (post, browse request, browse action, display mode change, etc.), and the body section indicates the content thereof (in the case of post, text or picture data, or in the case of browse action, data indicating the target post content, data indicating the type of the browse action, and the like). The reception data 95 is various data received from the server 20, and for example, contains a browse source and the like.

Besides, in the main memory 15, various data used in processing by the terminal apparatus 10 (for example, data for temporarily storing a post content before transmission) are also stored as appropriate.

Next, with reference to flowcharts in FIG. 15 and FIG. 16, the flows of processes executed by the terminal apparatus 10 and the server 20 in the exemplary embodiment will be described.

First, with reference to FIG. 15, the details of a process in the terminal apparatus 10 will be described. In the terminal apparatus 10, when a user performs an operation to start the SNS client process, first, in step S1, preparation processing is performed. In this processing, various kinds of data are initialized. Further, processing of transmitting a predetermined browse request to the server 20 and receiving a browse source from the server 20 is also performed in order to display an initial screen. Then, processing of generating a browse screen and displaying the browse screen as an initial screen on the screen is also performed. Regarding the display mode, it is assumed that the “first display mode” is selected in the default condition. Therefore, it is assumed that the browse screen at this time is also displayed in the first display mode.

Next, in step S2, the processor 13 acquires the operation data 93. In the next step S3, the processor 13 determines whether or not the operation content indicates a “posting” operation, based on the operation data 93. As a result, if the operation is a “posting” operation (YES in step S3), in step S10, the processor 13 executes processing of generating transmission data 94 containing a user ID and a post content of a posting person, and the like, and transmitting the transmission data 94 to the server 20.

Next, in step S11, the processor 13 transmits a predetermined browse request (for example, a request for a browse screen containing the latest posts at this point of time). Next, in step S12, the processor 13 receives a browse source transmitted from the server 20, and stores the browse source into the reception data 95. Then, based on the browse source, the processor 13 generates a browse screen as described above and displays the browse screen on the screen. Thereafter, the process proceeds to step S7.

On the other hand, as a result of the determination in step S3, if the operation is not a “posting” operation (NO in step S3), in step S4, the processor 13 determines whether or not the operation content indicates an operation corresponding to “browse action”. As a result, if the operation corresponds to a browse action (YES in step S4), in step S8, the processor 13 executes processing of generating transmission data 94 indicating the content of the browse action, and transmitting the transmission data 94 to the server 20. Thereafter (after a notification of reception completion or the like from the server is received), the process proceeds to step S11.

On the other hand, as a result of the determination in step S4, if the operation is not even a “browse action” operation (NO in step S4), next, in step S5, the processor 13 determines whether or not an operation to switch the display mode has been performed. As a result, if an operation to switch the display mode has been performed (YES in step S5), in step S9, in accordance with this instruction content, the processor 13 generates transmission data 94 indicating a request for a browse source corresponding to the first display mode or the second display mode, and transmits the transmission data 94 to the server 20. Thereafter, the process proceeds to step S12.

On the other hand, as a result of the determination in step S5, if also an operation to switch the display mode has not been performed (NO in step S5), in step S6, the processor 13 executes another processing in the SNS process as appropriate.

Next, in step S7, the processor 13 determines whether or not a condition for ending the process is satisfied (for example, whether or not an ending operation has been performed). If the condition is not satisfied (NO in step S7), the process returns to step S2 to repeat the processing. On the other hand, if the condition is satisfied (YES in step S7), the SNS client process in the terminal apparatus 10 is ended.

Next, with reference to FIG. 16, the details of a process by the server 20 will be described. In the server 20, when the SNS server process is started, first, in step S31, the processor 23 executes preparation processing. In this processing, various kinds of data are initialized.

Next, in step S32, the processor 23 executes processing of waiting for a browse request or the like from the terminal apparatus 10. Next, in step S33, the processor 23 determines whether or not transmission data 94 (containing a browse request or the like) has been received from the terminal apparatus 10. As a result, if such transmission data 94 has not been received (NO in step S33), the process returns to step S32 to repeat the waiting processing. On the other hand, if such transmission data 94 has been received (YES in step S33), in step S34, the processor 23 analyzes the content of the received transmission data 94 (hereinafter, may be referred to as a request content) by referring to the reception data 65. For example, by referring to a header section of the reception data 65, the kind of the transmission content (post or browse action, etc.) is determined.

Next, in step S35, the processor 23 determines whether or not the request content from the terminal apparatus 10 is “post”. As a result, if the request content is “post”, in step S40, based on the reception data 65, the processor 23 stores, in the post content data 63, a post content contained in the reception data 65, such that the post content is associated with a user ID of a posting user of the post content (a user ID 66 of the posting user is set for the posting person ID 82). Thereafter, the process returns to step S32 to repeat the processing.

On the other hand, as a result of the determination in step S35, if the request content is not “post” (NO in step S35), next, in step S36, the processor 23 determines whether or not the request content from the terminal apparatus 10 is “browse action”. As a result, if the request content is “browse action”, in step S41, the processor 23 specifies the type of the browse action contained in the reception data 65. Then, the processor 23 searches for the post content record 81 that is a target of the browse action, in the post content data 63, and stores matters representing the browse action into the browse action data 85 of said post content record 81. Then, the process returns to step S32 to repeat the processing.

On the other hand, as a result of the determination in step S36, if the request content is not even “browse action” (NO in step S36), in step S37, the processor 23 determines whether or not the request content from the terminal apparatus 10 is one of “request for browse source” and “change of display mode”. As a result, if the request content is one of “request for browse source” and “change of display mode” (YES in step S37), in step S42, the processor 23 executes processing of generating a browse source corresponding to the request content. More specifically, in this processing, if the request content is “request for browse source”, based on the reception data 65 and the user data 62, a post content to be contained in a browse screen is extracted from the post content data 63. For example, based on the “friend” relationship of the user who has transmitted the request, and posting dates, post contents are extracted. Further, for each of the extracted post contents, the display manner is determined by referring to the browse action data 85. For example, for each post content, if the number of browse action records contained in the browse action data 85 is equal to or greater than a predetermined value, the font size or the display area of the post content is determined to be enlarged. For example, a parameter (font size or area size) for display manner change is determined. The parameter for display manner change may be a value set in advance or may be changed in accordance with the number of browse action records (for example, the larger the number of browse action records is, the greater the parameter may be). It is noted that an upper limit value is set in advance for the parameter so that the font size or the display area is not enlarged beyond the upper limit value. Then, the processor 23 generates a browse source that provides listed display of post contents in the determined display manner (based on the determined parameter).

In the exemplary embodiment, as described above, the display manner is determined for each post content. In another exemplary embodiment, in the processing in step S42, the display manner may be determined on a “posting person” basis as described above. For example, in the case where, regarding a certain user, there are some post contents for each of which the number of browse action records contained in the corresponding browse action data 85 is equal to or greater than a predetermined value, and the number of such post contents is equal to or greater than a predetermined value, the display manner may be changed also for other post contents (contained in the above browse source) of the certain user who has posted such post contents.

On the other hand, in the case where the request content is “change of display mode”, processing of determining the display manner in accordance with the designated display mode is also executed. That is, the following processing is performed. If the first display mode is designated, a browse source is generated by the processing as described above. On the other hand, if the second display mode is designated, a user for whom the display manner is to be changed is specified by referring to the favorite user data 69 for a user who has transmitted the request. Next, post contents to be contained in a browse screen are extracted from the post content data 63. Further, whether or not there is a post content posted by such a user for whom the display manner is to be changed as described above among the extracted post contents is determined. Then, if there is such a post content, the display manner for the post content of the user is determined to be changed as appropriate. At this time, for example, the font size may be changed in accordance with the number of times of browse actions performed for each user. Then, the processor 23 generates a browse source that provides display in the display manner thus determined.

Next, in step S43, the processor 23 generates transmission data containing the generated browse source, and transmits the transmission data to the terminal apparatus 10 that is a request source. Thereafter, the process returns to step S32 to repeat the processing.

Next, as a result of the determination in step S37, if the request content from the terminal apparatus 10 is not “request for browse source” or “change of display mode” (NO in step S37), in step S38, the processor 23 executes another processing as appropriate.

Next, in step S39, the processor 23 determines whether or not a condition for ending the process is satisfied. If the condition is not satisfied (NO in step S39), the process returns to step S32 to repeat the processing. On the other hand, if the condition is satisfied (YES in step S39), the SNS server process in the server 20 is ended.

Thus, in the exemplary embodiment, a post content for which a browse action has been performed is displayed such that the display manner thereof is changed in accordance with the number of times of such browse actions, or the like. In other words, while a user just utilizes SNS as usual, the display manner for post contents is (gradually) changed. Thus, as shown in the above-described first display mode, it is possible to provide a browsing person with a browse screen in which browse actions mainly by users other than the browsing person are reflected in the display manner for post contents. As a result, the browsing person can efficiently grasp a post content that is popular or is highly evaluated at this time, or the like, thus enabling further efficient browsing and the like. In addition, as shown in the above-described second display mode, it is also possible to provide a browse screen in which browse actions by the browsing person are reflected in the display manner of post contents. Thus, it is possible to further efficiently grasp and browse a post content of a user whom the browsing person is highly familiar with or focuses on. In either case of first display mode or second display mode as described above, the browsing person can further efficiently browse a post content that the browsing person desires to browse.

Regarding change of the display manner in accordance with a browse action, in the above exemplary embodiment, an example in which the type (font size or the like) of change of the display manner is determined in accordance with the number of browse action records, has been shown. Instead, in calculation of the number of browse action records, filtering may be performed using the action type 88. For example, the number of browse action records whose browse action types are “positive evaluation” may be calculated. That is, the display manner may be changed in consideration of whether each browse action is “positive evaluation” or “negative evaluation”. As an example, basically, the font size may be gradually increased in accordance with the number of times of positive evaluations (the number of browse action records indicating “positive evaluation”), and the increased font size may be returned in accordance with the number of times of negative evaluations (the number of browse action records indicating “negative evaluation”). In addition, when there are many negative evaluations, the font size may be decreased to be smaller than the default font size. Further, as a result of negative evaluation, besides change of the font size, the font color may be changed to a color that gives a negative impression.

In addition, regarding a browse action which serves as a determination material for whether or not to change the display manner, a period limitation may be set for usage of browse actions in the determination. For example, the display manner may be determined based on browse actions performed within the last one month (such browse actions can be determined based on the action date 87, for example). Thus, for example, in the case where a user has posted a post content one year ago and thereafter the user has not posted any post content, it is possible to prevent the display manner of the post content from being kept conspicuous for a long time. In addition, for example, in the case where there have been many positive evaluations for post contents posted by a certain user three months ago but there have been many negative evaluations for post contents posted within the last one month, that is, in the case where posts of a certain user were more popular before but recent posts of the certain user become less popular, display can be performed without changing the display manner for the certain user. In addition, conversely, in the case where there is a post content that was not popular but has become popular or has been much talked about recently, it is possible to make the post content (and a user who has posted the post content) conspicuous by changing the display manner thereof. Thus, it is possible to provide a user with a browse screen in which “trend” of popularity and attention about post contents at the time of browsing is reflected.

In another exemplary embodiment, evaluation for a posting person may be further directly performed, not via browse actions to each post content as described above. For example, in the case where a user A browses a post content of a user B and then likes the post of the user B though the user A does not particularly perform any browse action for the post, the user A may be allowed to designate or set the user B as “favorite posting person (favorite user)”. In this case, for example, the user B may be recorded in the favorite user data 69 by the user A performing a predetermined operation. Thus, even in the case where the user A has not performed any browse action for the post of the user B or the number of times of such browse actions is small, it is possible to display the user B's post content in a conspicuous manner in the second display mode. In addition, this may be applied also in the case of the above first display mode. For example, the display manner for post contents of a user who is set as “favorite user” by a predetermined number or more of users may be changed. Instead of changing the display manner based on either-or evaluation such as whether or not to designate/set a certain user as “favorite posting person (favorite user)”, for example, the user A may be allowed to set the degree of evaluation (evaluation value) for the user B, and the display manner for the user B's post contents may be changed (gradually, as an example) in accordance with a cumulative result of the degree of evaluation (evaluation value) for the user B by the user A.

In addition to change of the display manner for a post content, a sound output may be further used at the same time or screen control such as adjustment of scroll speed may be performed, in order to attract user's attention to the post content. For example, it is assumed that, with the terminal apparatus, a user is doing “skim through” while scrolling a browse screen. In this case, a timing at which the post content whose display manner is changed is contained within the display screen may be detected, and at this timing, control may be performed so as to emit a predetermined sound, vibrate the terminal apparatus, decrease the scroll speed, or temporarily stop scroll. For example, in the case of outputting sound, in generating a browse source data on the server side, a post content whose display manner is to be changed is further set such that “a sound will be outputted when this post content comes into the display screen” (for example, an HTML tag or a script is thus set). Then, the terminal apparatus detects a timing at which the post content for which the “sound output” setting is performed comes into the display screen, and at this timing, reproduces predetermined sound data (for example, sound data transmitted from the server to the terminal apparatus together with the browse source) stored in the terminal apparatus, thereby outputting sound. Instead, the above control may be performed by only the terminal apparatus without the server performing any particular processing. For example, the terminal apparatus may detect a timing at which the “post content whose display manner is changed” comes into the display screen, and may output a predetermined sound at this timing.

In addition, regarding the browse action data 85, in the above exemplary embodiment, an example in which the number of times a browse action has been performed is calculated based on the number of browse action records or the like has been shown. Instead, data or a parameter indicating “popularity” or “interest/concern degree” may be recorded separately. For example, a “popularity” parameter may be increased in accordance with the number of browse action records whose action types 88 indicate “positive evaluation”. Then, in the first display mode, change of the display manner may be determined based on the “popularity” parameter. In addition, for example, based on the favorite user data 69, a parameter indicating a user's “interest/concern degree” about another user may be calculated and recorded. For example, in the case where there is a certain user for whom a browse action indicating positive evaluation has been performed many times, the parameter value indicating “interest/concern degree” about the certain user may be increased. Then, in the second display mode, change of the display manner may be determined based on the parameter indicating “interest/concern degree”.

In addition, in another exemplary embodiment, the display manner may be further changed based on profile information of each user. For example, in the first display mode, among users who have posted contents for which the display manner is to be changed, the display manner may be further changed for a post content of a user having the same “hobby” as that of a browsing person (which is stored in the account information data 67). For example, while the display area is enlarged in accordance with a browse action, the character color may be changed for a post content of a user having the same hobby. As a result, when there is a post content whose display area is enlarged and whose character color is also changed as compared to other post contents, a browsing person can estimate that a posting person of the post content has the same hobby as the browsing person. Then, via such a common hobby, it can be expected that the browsing person has an increased familiar relationship with the posting person. This also applies in the second display mode. In addition, for example, the display manner may be changed such that the character color is different between “hobby” and “hometown” in the profile information.

In addition, the change type of the display manner may be designated by a browsing person. For example, on a predetermined setting screen, the change type of the display manner in the first display mode may be selected from among “enlargement of display area”, “enlargement of font size”, and “change of character color”.

In addition, when a user posts a post content, the user may designate the display manner thereof to some extent. That is, at the time of posting, the display manner may be designated to some extent so that a post content can be posted with a display manner different from the normal state. The change types that can be designated here may be different from the change types of the display manner determined based on a browse action in the above-described processing. For example, at the time of posting, a user may be allowed to designate the character color but may not be allowed to designate change of the font size, and on the other hand, change of the display manner in accordance with a browse action as described above may not allow change of the character color but may allow change of the font size.

In the above exemplary embodiment, an SNS that assumes a friend relationship as described above has been shown as an example. However, the above processing is also applicable to a service in which a friend relationship is not always necessary. For example, the above processing is also applicable to product review at a shopping site, video posting service, content posting board, etc. That is, by applying the above processing, it also becomes possible to change the display manner of a post content (review or posted video) in accordance with a browse action performed for the post content. As a result, a user can efficiently view a highly useful review (a review by a highly evaluated reviewer) or a posted video with high popularity, for example.

In addition, in the above exemplary embodiment, an example in which the server 20 performs the processing relevant to generation and transmission of a browse source that provides display with the display manner being changed in accordance with information about a browse action, has been shown. Regarding this processing by the server 20, in another exemplary embodiment, a server system may be formed by a plurality of information processing apparatuses, and the processing to be executed on the server 20 side may be shared by the plurality of information processing apparatuses.

While the exemplary embodiments have been described herein, it is to be understood that the above description is, in all aspects, merely an illustrative example, and is not intended to limit the scope thereof. It is to be understood that various modifications and variations can be made without deviating from the scope of the exemplary embodiments.

What is claimed is:

1. A server used in an information processing system that allows posting and sharing of a content by a user, the server comprising a processor configured to:
store information related to a browse action which is a predetermined operation performed, for a content posted by a user, by another user who browses the content;
determine, based on the information, a display manner for the content posted by the user or for another content posted by the user, so that the display manner becomes different from a display manner for a content in a normal state; and
generate browse source data for displaying the content in the determined display manner.

2. The server according to claim 1, the processor further configured to transmit the browse source data, wherein the processor,
determines the display manner, based on the information related to a browse action performed by a first user,
generates the browse source data for displaying a content to be browsed by a second user different from the first user, in the display manner determined based on the information related to the browse action performed by the first user, and
transmits the browse source data to the second user.

3. The server according to claim 1, wherein the processor,
stores the information related to a browse action in a cumulative manner, and
determines the display manner, based on a cumulative result of the browse actions.

4. The server according to claim 1, the processor further configured to transmit the browse source data, wherein the processor,
stores the information related to a browse action performed, by a first user, for a content of another user,
determines a display manner for a content that has been posted by the other user and that is to be browsed by the first user, based on the information related to the browse action performed by the first user,
generates the browse source data for displaying the content in the display manner determined based on the browse action performed by the first user, and
transmits the browse source data to the first user.

5. The server according to claim 1, wherein the processor repeatedly determines the display manner.

6. The server according to claim 1, wherein the processor,
generates browse source data so that a plurality of the contents are displayed, and
determines the display manner for each of the plurality of contents.

7. The server according to claim 1, wherein
the processor generates browse source data so that, on a browse screen which displays a content based on the browse source data, at least a part of each content contained in the browse source data is displayed, and
the browse action is an operation for requesting display of an entirety or a detail of the content that is displayed only partially.

8. The server according to claim 1, wherein
the processor generates browse source data so that a feedback button that allows feedback for each content displayed based on the browse source data is also displayed, and
the browse action is an operation that a browsing user pushes the feedback button.

9. The server according to claim 1, wherein the processor determines a display manner for a content for which the browse action has been performed, so that a display area thereof becomes larger than that of a content in the normal state.

10. The server according to claim 1, wherein the processor generates the browse source data so that contents displayed based on the browse source data are arranged in chronological order.

11. The server according to claim 1, the processor further configured to store profile information related to each user, wherein
the processor determines the display manner, based on a result of comparison of the profile information among the users, and based on the information related to the browse action.

12. The server according to claim 1, wherein the processor generates the browse source data so that, when a content for which the display manner is changed is displayed within a screen of a predetermined terminal that has received the browse source data, predetermined control other than change of the display manner, for attracting user's attention, is further performed on the predetermined terminal.

13. A non-transitory computer-readable storage medium having stored therein an information processing program to be executed by a computer of a server used in an information processing system that allows posting and sharing of a content by a user, the information processing program causing the computer to function to:
store information related to a browse action which is a predetermined operation performed, for a content posted by a user, by another user who browses the content;
determine, based on the information, a display manner for the content posted by the user or for another content posted by the user, so that the display manner becomes different from a display manner for a content in a normal state; and
generate browse source data for displaying the content in the determined display manner.

14. A server system used in an information processing system that allows posting and sharing of a content by a user, the server system comprising a processor configured to:
store information related to a browse action which is a predetermined operation performed, for a content posted by a user, by another user who browses the content;
determine, based on the information, a display manner for the content posted by the user or for another content posted by the user, so that the display manner becomes different from a display manner for a content in a normal state; and
generate browse source data for displaying the content in the determined display manner.

15. An information processing system that includes at least one server and a plurality of terminals and allows posting and sharing of a content by users with use of the terminals,
each terminal comprising a processor configured to:
transmit a content to the server;
transmit, to the server, a browse request indicating a request for displaying a browse screen for displaying the content;
transmit, to the server, information related to a browse action which is a predetermined operation performed for the content by a user who browses the content; and
receive browse source data as a base of the browse screen from the server, and generate and display the browse screen based on the received browse source data, and
the server comprising a processor configured to:
receive the content transmitted from a user;
store information related to the transmitted browse action;
determine, based on the information, a display manner for the content posted by the user or for another content posted by the user, so that the display manner becomes different from a display manner for a content in a normal state;
generate, in accordance with reception of the browse request, the browse source data for displaying the content in the determined display manner; and
transmit the generated browse source data to the terminal that has performed the request.

16. The information processing system according to claim 15, wherein the processor,
generates the browse source data so that a plurality of the contents are contained in the browse screen,
generates and displays the browse screen containing the plurality of contents,
transmits the information related to a browse action performed for one of the contents contained in the browse screen,
determines, in accordance with a browse request performed after the transmitted information related to the browse action has been stored, a display manner for the content for which the browse action has been performed, based on the transmitted information,
generates the browse source data so that the display manner for the content for which the browse action has been performed is changed to the determined display manner, and
transmits the browse source data containing the content for which the display manner is changed, to the terminal that has performed the browse request.

17. A server used in an information processing system that allows posting and sharing of a content by a user, the server comprising a processor configured to:
store information related to a browse action which is a predetermined operation performed, for a user who has posted a content, by another user;
determine, based on the information related to the user who has posted the content, a display manner for contents of the user who has posted the content, so that the display manner becomes different from a display manner for a content in a normal state; and
generate browse source data for displaying the content in the determined display manner.
